(19) United States
(12) Patent Application Publication
(10) Pub. No.: US 2005/0212164 A1
(43) Pub. Date: Sep. 29, 2005

(54) Method and apparatus for hauling off extrusion products, in particular for aligning the caterpillar take-off device in relation to the extrusion axis

(75) Inventors: Henning Stieglitz, Munchen (DE); Roman Laberer, Oberroth (DE); Stefan Jovers, Waldkraiburg (DE); Andreas Weinmann, Blieskastel (DE); Karl-Heinz Forsch, Blieskastel-Breitfurt (DE); Karl-Heinz Baston, Contwig (DE)

Correspondence Address: HENRY M FEIEREISEN, LLC, 350 FIFTH AVENUE, SUITE 4714, NEW YORK, NY, 10118, US

(73) Assignee: KRAUSS-MAFFEI KUNSTSTOFFTECHNIK GMBH, Munchen (DE)

(21) Appl. No.: 11/064,440

(22) Filed: Feb. 22, 2005

Related U.S. Application Data
(63) Continuation of application No. PCT/EP03/09022, filed on Aug. 14, 2003.

(30) Foreign Application Priority Data
Sep. 4, 2002 (DE) 102 40 718.5

(51) Int. Cl. B62D 55/00; B29C 37/02

(52) U.S. Cl. 264/138

(57) ABSTRACT

A caterpillar take-off device for hauling off extrusion products, in particular plastic tubes, includes at least two caterpillar tracks arranged symmetrically in relation to a length axis of the caterpillar take-off device, at least during take-off process by changing the distance from the caterpillar tracks to the length axis. In the event of a change in cross-section of the extrusion product, the change is measured and the distance of the caterpillar tracks from the length axis is automatically adjusted such that the symmetry axis of the extrusion product coincides with the longitudinal axis of the caterpillar take-off unit.

### CROSS-REFERENCES TO RELATED APPLICATIONS

This application is a continuation of prior filed copending PCT International application no. PCT/EP2003/009022, filed Aug. 14, 2003, which designated the United States and on which priority is claimed under 35 U.S.C. §120, and which claims the priority of German Patent Application, Serial No. 102 40 718.5, filed Sep. 4, 2002, pursuant to 35 U.S.C. 119(a)-(d).

### BACKGROUND OF THE INVENTION

The present invention relates, in general, to a method and apparatus for taking off extrusion products.

Nothing in the following discussion of the state of the art is to be construed as an admission of prior art.

The production of extrusion products, including plastic tubes, involves shaping of the extruded thermoplastic melt strand in a molding tool and subsequent cooling and calibrating. Take-off devices disposed in the extrusion line downstream of the calibrating and cooling devices are intended to convey the melt strand, emerging from the extruder, through the various intermediately positioned devices. The extrusion product which is produced from the melt strand after being shaped and calibrated and has sufficient strength following the cool-down period, is grasped by the take-off device and transported jerk-free and at even speed or precisely controlled speed pattern through the various devices. Naturally, the take-off device has to apply a take-off force which exceeds the friction forces encountered in these devices. At the same time, the take-off force has to be suited to the size, cross section, type, and wall thickness of the extrusion product being conveyed.

German Pat. No. DE 33 05 175 describes a caterpillar take-off device which applies the required take-off force into the tube by means of circulating conveyor chains, so-called caterpillar tracks, which are provided with rubber shoes and have a conveyor surface in parallel relationship to the extrusion product being transported. The rubber shoes should be as wear-resistant as possible while still exhibiting a good adhesion of the caterpillar tracks upon the surface of the extrusion products. In order to avoid uneven wear of the caterpillar tracks and an unwanted twisting of the extrusion products during take-off, the caterpillar tracks engage the extrusion product as symmetrically as possible. In the event of a tube extrusion, the caterpillars are thus attached cylindrically symmetrical to a length axis of the take-off device which must coincide with the symmetry axis of the transported tube in order to prevent an unwanted twisting or uneven stress of the tube.

Depending on the tube diameter, it is also known to use, for example, four caterpillar tracks which are arranged in the form of an X about a length axis of the take-off device. To keep the stress on the tube to a minimum, the tube should enter the take-off device in midsection, i.e. the symmetry axis of the tube should coincide with the length axis of the take-off device. The lower caterpillars are hereby movable via mechanical adjustment units along the leg of the X whereas the upper caterpillars are urged into contact with the tube by pneumatic cylinders which act also along the legs of the X. The pressure applied by the pneumatic cylinders is freely adjustable and must be matched to the dimension and wall thickness of the tubes. During production of tubes with very slight wall thickness, it becomes necessary to impose on the pneumatic cylinders a counterpressure which opposes the gravity acting on the upper caterpillars, to ensure a sufficient force transmission of caterpillar tracks and to prevent damage to the extrusion product.

Conventional take-off devices suffer shortcomings because the caterpillar take-off device must be readjusted each time a change in production is accompanied by a change in diameter of the extrusion product. Without readjustment, the symmetry axis of the extruded material would no longer coincide with the length axis of the take-off device. As a consequence, the whole extrusion line must be halted, resulting in production downtimes.

It would therefore be desirable and advantageous to provide an improved method and apparatus for hauling-off extrusion products to obviate prior art shortcomings and to allow recognition of cross sectional changes of the extrusion product so as to maintain a coincidence between the symmetry axis of the extrusion product and the length axis of the take-off device.

### SUMMARY OF THE INVENTION

According to one aspect of the present invention, a method of taking off extrusion products, in particular plastic tubes, includes the steps of providing a caterpillar take-off device having at least two caterpillar tracks for taking off an extrusion product, measuring a change in cross section of the extrusion product, and automatically adjusting the distance between the caterpillar tracks in dependence on the change in cross section to provide a symmetric disposition of the caterpillar tracks in relation to a length axis of the take-off device at least during a take-off operation so that a symmetry axis of the extrusion product coincides with the length axis of the take-off device.

The present invention resolves prior art problems by constructing the take-off device to spontaneously recognize changes in cross section of the extrusion product in the event of a production change, and to initiate immediate steps to correct the position of the caterpillar tracks so that the extrusion product continues to centrally enter the take-off device. The adjustment to a change in diameter or cross section occurs during operation of the apparatus so that the need for a shutdown and renewed start-up is eliminated and resultant uncontrolled changes of process parameters are avoided. A take-off device according to the present invention enables the operator to retrofit the apparatus in a very short time.

A system control unit for the extrusion line constructed is easy to construct because it is only required to communicate to the take-off device the line speed and the contact pressure and counterpressure to be applied by the caterpillar tracks upon the extrusion product. In addition to the fully automated adjustment to any changes in cross section of an extrusion product in the extrusion line, it is also possible to carry out the adjustment by hand at the take-off device.

According to another feature of the present invention, the change in cross section of the extrusion product can be determined in response to a deflection of the caterpillar tracks from their original position, whereby in dependence on the determined absolute variable, the distances between the individual caterpillar tracks and the length axis of the take-off device are automatically adjusted so that the extrusion product runs centrally through the and all force impacts occur substantially symmetrical.

It is hereby possible, to measure the deflection of caterpillar tracks which are located above a plane, defined by the horizontal and the length axis of the take-off device, and to move the caterpillar tracks below or in this plane in response to the measured deflection until a symmetric disposition of the caterpillar tracks about the extrusion product and the length axis of the take-off device is re-established.

According to another feature of the present invention, the upper caterpillar tracks may be urged against the extrusion product by controllable, elastic device. In this way, an even pressure is generated on all caterpillar tracks. This contact pressure is set by the system control unit of the extrusion line in dependence on material and dimension.

According to another feature of the present invention, the measured deflection can be directly transmitted to a control unit for computing a needed change in the distance between the caterpillar tracks and for initiating this change in distance. This control unit may also be used for simultaneously controlling the contact pressure.

According to another aspect of the present invention, a method of producing an extrusion product, in particular a plastic tube, includes the steps of extruding a melt strand in an extruder, shaping the melt strand in a die into a molten tube, cooling down and calibrating the molten tube to produce an extrusion product, hauling-off the extrusion product by a take-off device having at least two spaced-apart caterpillar tracks, whereby a distance between the caterpillar tracks from a length axis of the take-off device is determined and automatically adjusted in response to a change in diameter of the extrusion product so that a symmetry axis of the extrusion product coincides with the length axis of the take-off device, and cutting the extrusion product into single pieces.

According to still another aspect of the present invention, a take-off device for hauling-off an extrusion product, in particular a plastic tube, includes at least two caterpillar tracks constructed for symmetric disposition in relation to a length axis of the take-off device during take-off operation, a first mechanism for pressing the caterpillar tracks against the extrusion product, a second mechanism for measuring a deflection of the caterpillar tracks in orthogonal relationship to the length axis, and a third mechanism for changing a distance between the caterpillar tracks and the length axis of the take-off device in response to the deflection measurement by the second mechanism.

At least during operation, i.e. during conveyance of the pulled-in extrusion product, the caterpillar tracks are thus arranged in symmetric disposition to the length axis of the caterpillar take-off device and apply a contact pressure upon the extrusion product so as to enhance the force transmission between caterpillar tracks and extrusion product. When the extrusion product has very small cross section or thin wall thickness, the contact pressure applied by the gravity of the caterpillar tracks situated above the extrusion product can be reduced by applying a counterpressure so as to prevent damage to the extrusion product. Still, sufficient take-off force is transmitted for transport of the extrusion product through the devices between extruder and take-off device.

The contact pressure and counterpressure upon the caterpillar tracks can be generated by using piston and cylinder units which can operate at a predetermined pressure and have piston rods moveable orthogonal to the length axis of the take-off device, whereby their effective lines intersect on the length axis. Suitably, only those caterpillar tracks which are positioned above a plane defined by the horizontal plane and the length axis of the take-off device are elastically and controllably supported by the piston and cylinder units, while the caterpillar tracks situated below or in this plane are mechanically movable and controllable.

The use of automatically controllable piston and cylinder units is currently preferred because there is only need to provide the desired pressure to be maintained. Suitably, the piston and cylinder units include pneumatic cylinders.

A mechanical change of the distance between those caterpillar tracks that are not linked to the piston and cylinder units and the length axis of the take-off device can be realized by using at least one motor. As all caterpillar tracks should have a same distance to the firmly defined length axis in order to realize a symmetric distance change, the use of a single motor is sufficient. Suitably, the motor is operatively connected to the lower caterpillar track via a gear mechanism.

According to another feature of the present invention, the deflection measurement of the caterpillar tracks in response to an encountered change in diameter or cross section of the extrusion product may involve the use of a displacement pick-up. As an alternative, it may also be possible to use at least one angle position transducer. The angle position transducer may be attached on the gear mechanism or shaft of the motor and allows implementation of a precise movement of the caterpillar tracks, positioned below or in the horizontal plane, along the connecting lines to the length axis.

According to another feature of the present invention, a displacement pick-up may be provided on the piston and cylinder units for measuring the deflection of the caterpillar tracks, which are elastically supported on the piston and cylinder units, when an extrusion product with different cross section is in the extrusion line, and for transmitting information about the measured deflection to the control unit of the take-off device. On the basis of the measured deflection, the control unit computes the required modification in distance between the caterpillar tracks in or below the horizontal plane and the length axis of the take-off device and causes the caterpillar tracks to shift accordingly. The caterpillar tracks above the plane are also moved along the connecting line to the length axis and orthogonal thereto, as a consequence of the applied contact pressure when the caterpillar tracks in or below the plane change their position, so that all caterpillar tracks are again arranged symmetrically about the length axis.

In addition to the fully automated recognition of a cross sectional change of the extrusion product and the triggered adjustment and recalibration of the relative position of the caterpillar tracks, it is, of course, also possible, to adjust the take-off device according to the invention by hand. A manual adjustment is required, e.g., when the production parameters dictate a complete change-over of the extrusion line.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic illustration of a tube extrusion line having incorporated a caterpillar take-off device according to the present invention;

FIG. 2 is a schematic section of a caterpillar take-off device according to the present invention for taking-off a tube;

FIG. 3 is a schematic illustration of the caterpillar take-off device of FIG. 2 immediately following a change of extrusion product with different tube diameter;

FIG. 3a is a schematic block diagram showing the relationship and operation of components of the take-off device; and

FIG. 4 is a schematic illustration of the caterpillar take-off device of FIG. 3 after corrective measures.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

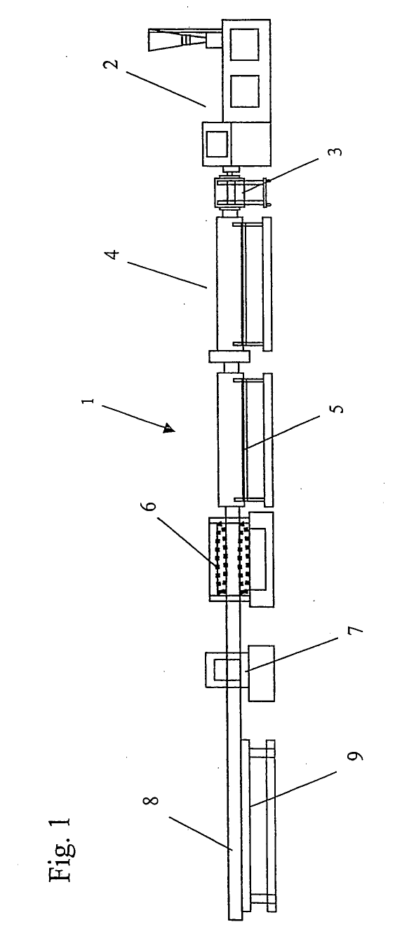

Turning now to the drawing, and in particular to FIG. 1, there is shown a schematic illustration of an extrusion line, generally designated by reference numeral 1 for producing plastic tubes 8. The extrusion line includes an extruder 2 which is followed by a tubular die 3 for producing a molten tube. The die 3 is followed by a vacuum tank 4 for calibrating the extruded tube and a cooling device 5 by which the tube 8 is cooled down to have sufficient stable shape to withstand the strain applied by a downstream take-off device 6 according to the present invention. The take-off device 6 applies upon the tube 8 a take-off force which is greater than the friction forces encountered during advance through the extrusion line 1 in particular during calibration in the vacuum tank 4, along transitions and seals. The take-off device 6 is followed by a separating device 7 by which the tubes 8 are cut to size, and a stacking device 9.

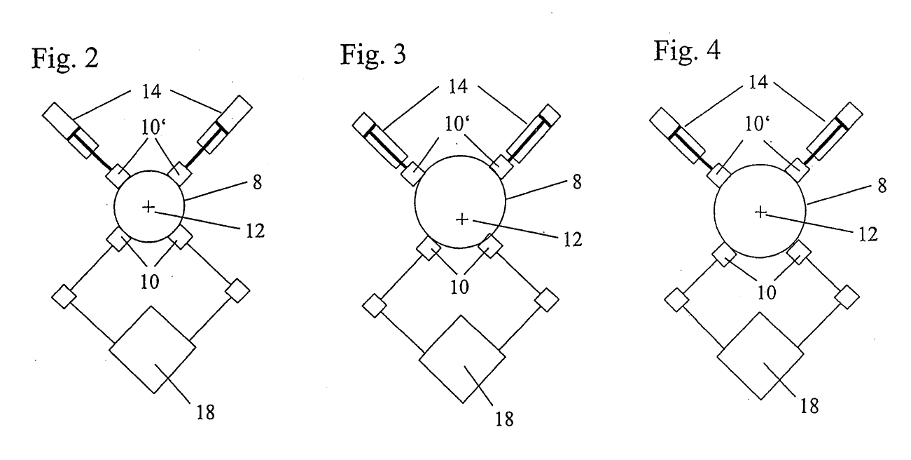

Referring now to FIG. 2, there is shown in greatly simplified manner a schematic cross section of the take-off device 6. The take-off device 6 includes caterpillar tracks 10, 10′ arranged in symmetric relationship in the form of an X for transporting the extruded tube 8. The caterpillar tracks 10, 10′ are arranged symmetrically to a length axis 12 of the take-off device 6, whereby the length axis 12 coincides with the symmetry axis of the tube 8. In the non-limiting example of FIG. 2, the caterpillar tracks 10′, which are arranged above the horizontal plane through the length axis 12, are acted upon by pneumatic cylinders 14 to impose a sufficient contact pressure for urging all caterpillar tracks 10, 10′ against the wall surface of the tube 8.

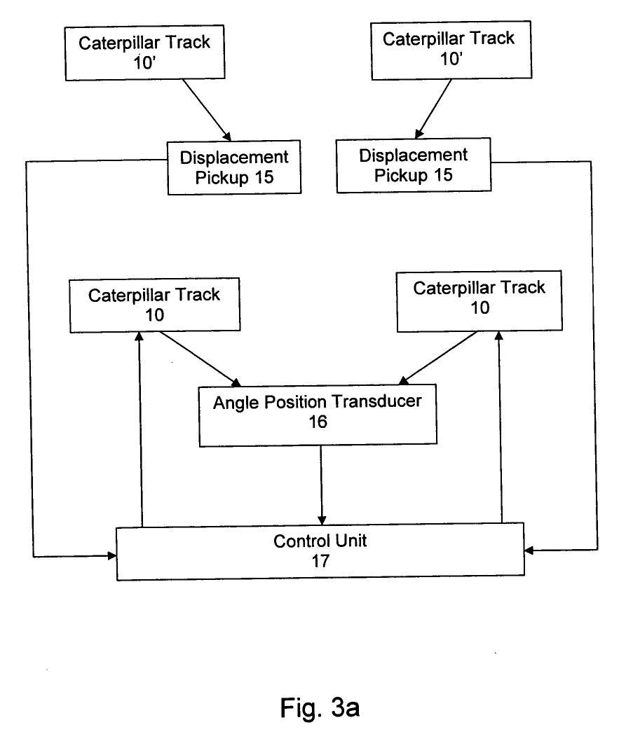

In the event, the extruded tube 8 has different diameter, both upper caterpillar tracks 10′ are deflected in opposition to the pressure applied by the pneumatic cylinders 14 so that the disposition between the caterpillar tracks 10′, positioned above the plane defined by the horizontal and the length axis 12, and the caterpillar tracks 10, positioned below the plane, is momentarily no longer symmetric in relation to the length axis 12. In other words, the symmetry axis of the tube 8 does no longer coincide with the length axis 12 of the take-off device 6. This situation is shown in FIG. 3.

This deflection by the caterpillar tracks 10′ is detected by displacement pickups 15 (FIG. 3a) on the pneumatic cylinders 14. The displacement pickups 15 measure the deflection and generate respective signals for transmission to a control unit 17 (FIG. 3a) which instantly corrects the distance of the lower caterpillar tracks 10 from the length axis 12 with the assistance of an angle position transducer 16 on motor 18 so as to reestablish a symmetric disposition of the caterpillar tracks 10, 10′ about the length axis 12, as shown in FIG. 4, and thus to ensure an optimum advance of the tube 8 at minimum wear of the caterpillar tracks 10, 10′.

The advantage of a take-off device according to the present invention is the capability to automatically recognize any change in cross section during production of extrusion products in an extrusion line and to spontaneously make the appropriate optimum readjustment. As a result, the operation runs smoothly, without experiencing cost-intensive production downtimes, as caused by manual adjustments.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A method of taking-off extrusion products, in particular plastic tubes, comprising the steps of:
providing a caterpillar take-off device having at least two caterpillar tracks for taking off an extrusion product;
measuring a change in cross section of the extrusion product; and
automatically adjusting the distance between the caterpillar tracks in dependence on the change in cross section to provide a symmetric disposition of the caterpillar tracks in relation to a length axis of the take-off device at least during a take-off operation so that a symmetry axis of the extrusion product coincides with the length axis of the take-off device.

2. The method of claim 1, wherein the adjusting step includes a deflection of an upper one of the caterpillar tracks in response to the change in cross section of the extrusion product, measurement of the deflection, and moving a lower one of the caterpillar tracks in response to the measured deflection until a symmetry axis of the extrusion product coincides with the length axis of the take-off device.

3. The method of claim 2, and further comprising the step of urging the upper one of the caterpillar tracks against the extrusion product by controllable, elastic means.

4. The method of claim 2, and further comprising the step of transmitting the measured deflection to a control unit for computing a required change in distance between the caterpillar tracks and for initiating the change in distance.

5. A method of producing an extrusion product, in particular a plastic tube, comprising the steps of:
extruding a melt strand in an extruder;
shaping the melt strand in a die into a molten tube;
cooling down and calibrating the molten tube to produce an extrusion product;
taking-off the extrusion product by a caterpillar take-off device having at least two spaced-apart caterpillar tracks, whereby a distance between the caterpillar tracks from a length axis of the take-off device is determined and automatically adjusted in response to a change in diameter of the extrusion product so that a symmetry axis of the extrusion product coincides with the length axis of the take-off device; and
cutting the extrusion product into single pieces.

6. A caterpillar take-off device for taking-off an extrusion product, in particular a plastic tube, comprising:
at least two spaced-apart caterpillar tracks constructed for symmetric arrangement in relation to a length axis of the take-off device during a take-off operation;
first means for pressing the caterpillar tracks against the extrusion product;
second means for measuring a deflection of the caterpillar tracks in orthogonal relationship to the length axis; and
third means for changing a distance between the caterpillar tracks and the length axis of the take-off device in response to the deflection measurement by the second means.

7. The take-off device of claim 6, wherein the first means includes a piston and cylinder unit having a piston rod moveable orthogonal to the length axis of the take-off device.

8. The take-off device of claim 7, wherein the caterpillar tracks are positioned to define an upper caterpillar track and a lower caterpillar track in relation to a horizontal plane intersecting the length axis, said piston and cylinder unit being provided exclusively for the upper caterpillar track.

9. The take-off device of claim 7, wherein the piston and cylinder unit is constructed for automatic pressure control.

10. The take-off device of claim 7, wherein the piston and cylinder unit is constructed as pneumatic cylinder.

11. The take-off device of claim 8, wherein the third means includes at least one motor.

12. The take-off device of claim 11, wherein the motor is operatively connected to the lower caterpillar track.

13. The take-off device of claim 11, wherein the third means includes a gear mechanism disposed between the motor and the lower caterpillar track.

14. The take-off device of claim 6, wherein the second means includes a displacement pick-up.

15. The take-off device of claim 6, wherein the second means includes an angle position transducer.

16. The take-off device of claim 15, wherein the third means includes at least one motor operatively connected to at least one of the caterpillar tracks, said angle position transducer being provided on the motor for measuring the deflection.

17. The take-off device of claim 7, wherein the second means includes a displacement pick-up provided on the piston and cylinder unit.

18. The take-off device of claim 6, wherein the third means includes a control unit rendered operative in response to signals received from the second means in dependence on the deflection measurement.

19. The take-off device of claim 6, and further comprising means for manual control of the distance between the caterpillar tracks and the length axis of the take-off device.
